(19) United States
(12) Patent Application Publication
(10) Pub. No.: US 2008/0095620 A1
(43) Pub. Date: Apr. 24, 2008

(54) Sync method for reducing fan noise

(75) Inventor: Jay K. Osborn, Arcata, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/584,468

(22) Filed: Oct. 20, 2006

(51) Int. Cl. B64C 27/00

(52) U.S. Cl. 416/1

(57) ABSTRACT

A system and method for reducing noise generated by a plurality of fans for moving air includes setting a first fan of the plurality of fans at a predetermined speed; setting a second fan of the plurality of fans at the predetermined speed; and configuring the second fan of the plurality of fans to have a phase shift from the first fan of the plurality of fans. A system and method for reducing noise generated by a plurality of fans for moving air includes setting a first subgroup of fans of the plurality of fans at a predetermined speed; setting a second subgroup of fans of the plurality of fans at the predetermined speed; and configuring the second subgroup of fans of the plurality of fans to have a phase shift from the first subgroup of fans of the plurality of fans.

### BACKGROUND

Demand for better compact cooling systems that produce minimal noise is continually increasing. For instance, higher computing power requirements in ever-decreasing physical chassis volumes, especially for rack-mount servers and storage systems, is driving a dramatic rise in cooling airflow requirements in compact products. The requirement for easy hot-swap serviceability of air movers and the short height and depth available to them within compact system chassis pushes the use of many small axial-flow fans, usually to the detriment of acoustic noise emissions.

Small fans packed into tight spaces tend to emit substantial acoustic noise, of which a growing proportion is tonal and relatively high-frequency. Tonal noise is known to be particularly annoying to humans and a key impact on productivity in workplaces, even for temporary exposure. An example of a tonal noise component that may have a relatively high-frequency is the blade-pass tone, a product of the number of fan blades and the fan rotational frequency.

Noise from air movers in products has been reduced in the past by favoring larger, slower-spinning fans and blowers, and by separating the air movers from adjacent mechanical interfaces with deep inlet and exit plenums. These strategies had the double benefit of keeping fan-related noise tone frequencies low and preventing the generation of significant tones.

The packing density of newer systems and the significant rise in dissipated power density has resulted in design compromises that have increased the tonal noise problem. With the rise of tonal noise, the perception of a “beating” noise due to differences in speed between adjacent fans has also risen.

Some methods to suppress acoustical noise involve conventional passive noise reduction such as barriers, absorbing materials, and folded ducts. Other methods attempt to actively cancel fan-produced acoustical noise by emitting an inverse sound wave. U.S. Pat. No. 5,388,956 describes a method of attaching two fan blade sets to a single rotor, spacing the blade sets at a given axial distance and a determined angular offset so that blade-pass tones are cancelled. This approach is applicable to dual fans on a common shaft, and requires a duct to contain airflow and noise. U.S. Pat. No. 5,995,632 describes a method using a microphone and band-pass filtering circuit to detect system noise, and speaker to emit cancelling sound, tied by a closed-loop signal processing circuit and algorithm.

### SUMMARY

In general, in one aspect, embodiments of the invention relate to a method for reducing noise generated by a plurality of fans, including: setting a first fan of the plurality of fans at a predetermined speed; setting a second fan of the plurality of fans at the predetermined speed; and configuring the second fan of the plurality of fans to have a phase shift from the first fan of the plurality of fans.

In general, in one aspect, embodiments of the invention relate to a method for reducing noise generated by a plurality of fans including setting a first subgroup of fans of the plurality of fans at a predetermined speed; setting a second subgroup of fans of the plurality of fans at the predetermined speed; and configuring the second subgroup of fans of the plurality of fans to have a phase shift from the first subgroup of fans of the plurality of fans.

In general, in one aspect, the invention relates to a system for moving air using a plurality of fans including a first fan of the plurality of fans and a second fan of the plurality of fans. The first fan and the second fan are set to a predetermined speed. The second fan of the plurality of fans is configured to have a phase shift from the first fan of the plurality of fans.

In general, in one aspect, embodiments of the invention relate to a system for moving air using a plurality of fans includes a first subgroup of fans of the plurality of fans and a second subgroup of fans of the plurality of fans. The first subgroup of fans and the second subgroup of fans are set to a predetermined speed. The second subgroup of fans of the plurality of fans is configured to have a phase shift from the first subgroup of fans of the plurality of fans.

Other aspects and advantages of the invention will be apparent from the following description and the appended claims.

### BRIEF DESCRIPTION OF DRAWINGS

FIG. 1 shows a system in accordance with the one or more embodiments of the invention.

FIG. 2 shows an exemplary, single fan unit fully removed from a chassis for use in accordance with one or more embodiments of the present invention.

FIG. 3 shows a diagram of a system in accordance with the one or more embodiments of the invention.

FIG. 4 shows a diagram of a system in accordance with one or more embodiments of the invention.

FIG. 5 shows a diagram of a system in accordance with one or more embodiments of the invention.

FIG. 6 shows a diagram of a system in accordance with one or more embodiments of the invention.

FIG. 7A shows sound pressure from a fan of a system of fans in accordance with one or more embodiments of the invention.

FIG. 7B shows sound pressure from a fan of a system of fans in accordance with one or more embodiments of the invention.

FIG. 7C shows sound pressure from a system of fans in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, noise generated by a plurality of fans is reduced by setting each fan in the plurality of fans to the same speed and offsetting the phase (i.e. rotational phase) of each fan in the plurality of fans to reduce one or more noise components. In one or more embodiments of the invention the noise components reduced by the invention are relatively high frequency harmonic components such as a blade pass noise component. In one or more embodiments of the invention, each fan in the plurality of fans is set to the same speed, however, the speed may be temporally variable.

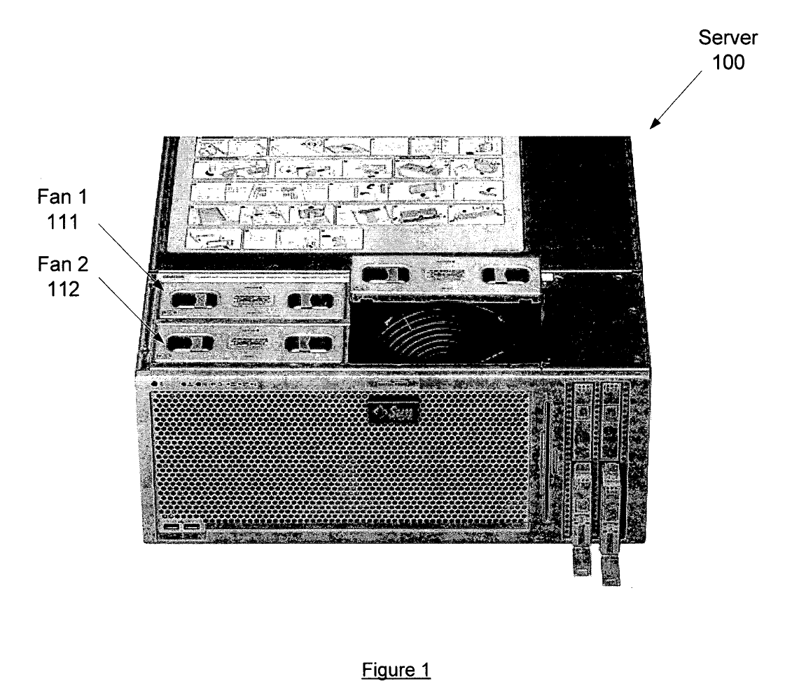

FIG. 1A shows a server (100) in accordance with one or more embodiments of the present invention. The server (100) has a plurality of fans, including a fan 1 (111) and a fan 2 (112). As can be seen, a similar set of fans is included in parallel with one fan partially removed for clarity. Other embodiments of the invention may have different types of fans, different sizes of fans, a greater number of fans, different configurations and/or a different chassis.

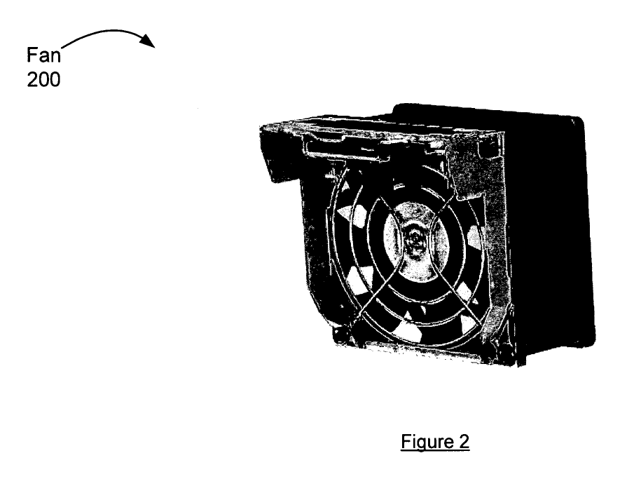

FIG. 2 shows an exemplary, single fan unit fully removed from a chassis for use in accordance with one or more embodiments of the present invention. Alternative embodiments of the invention may use different types and shapes of fans.

In one or more embodiments of the invention, a control scheme is used to lock the speed of all fans within a system to the same rate, while setting the phase shift (i.e. rotational phase shift) of the fans to reduce the noise emitted. In one or more embodiments of the invention a fan tachometer signal may be used as input to the control scheme. The control scheme may depend on a fixed relationship between blade position and tachometer position on the fan rotor. In one or more embodiments of the invention, similar types of fans are used to obtain maximum noise reduction.

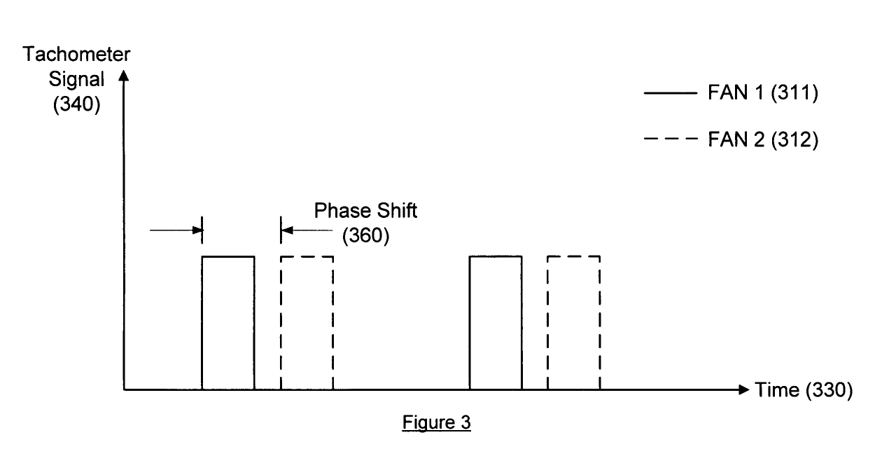

FIG. 3 shows an example of a control scheme in accordance with one or more embodiments of the invention. The exemplary control scheme uses a tachometer signal (340) to control the rate and phase of fan 1 (311) and fan 2 (312) as a function of time (330). Fan 1 (311) and fan 2 (312) are set to the same speed, and are set to have a phase shift (360). In one or more embodiments of the invention, the control scheme may use another device for controlling the rate (i.e. speed) and phase of a fan.

In one or more embodiments of the invention, the phase shift (360) of each fan in a system of fans is a fraction of the period of the noise component to be reduced through cancellation. The fraction is 1/x, where x is the total number of fans in the system. Each consecutive fan thereafter has the same phase shift from the previous fan. In one or more embodiments of the invention, the rate of each fan is similar.

For example, in a system with two fans, as shown in FIG. 3., fan 2 (312) has a phase shift (360) of ½ of the noise component period from fan 1 (311). If the noise component period is y, then the phase shift from the first fan is y/2 and the rate of each fan is similar.

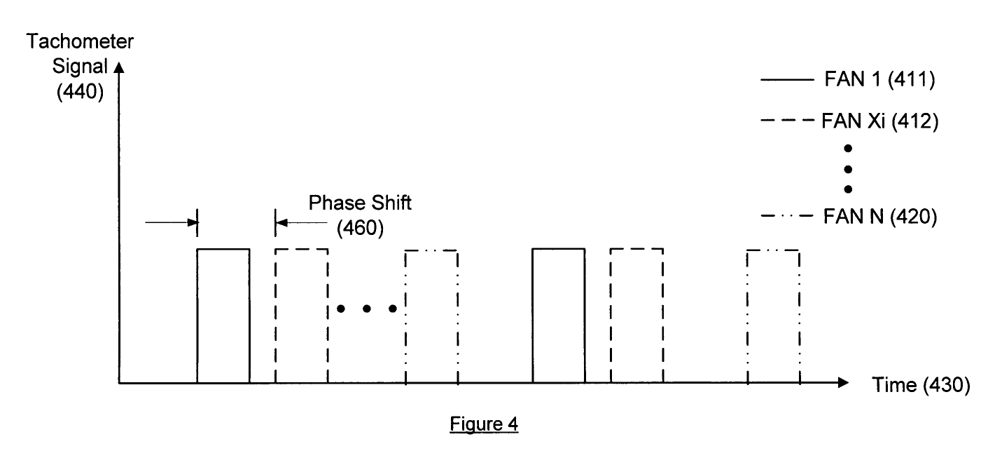

In a system with N fans, as shown in FIG. 4, where Xi (412) represents all fans between the first fan (411) and fan N (420) and ‘i’ represents the fan number from the first fan; the ‘Xi’ fan (412) has a phase shift of (i−1)/N of the noise component period from fan 1 (411). Fan N (420) has a phase shift of (N−1)/N of the noise component period from the first fan. Therefore, all fans in the system have the same rate, however, each fan has a different phase.

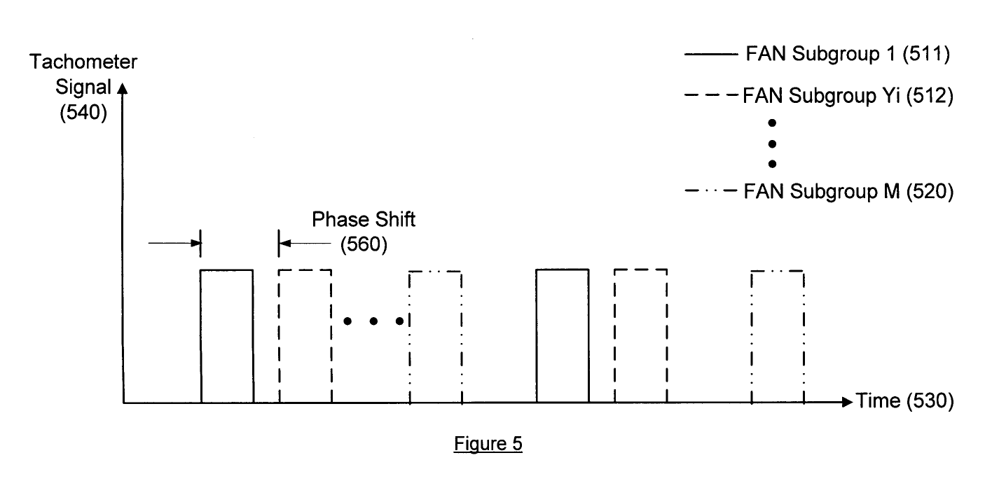

In one or more embodiments of the invention, as shown in FIG. 5, a system with M fans can be organized into subgroups where each subgroup has the same phase and rate. In one or more embodiments, each subgroup is mounted in parallel or closely mounted in series. The system shown in FIG. 5 is essentially configured in the same manner as the system shown in FIG. 4. However, instead of a single fan at each phase there may be a subgroup of fans at each phase.

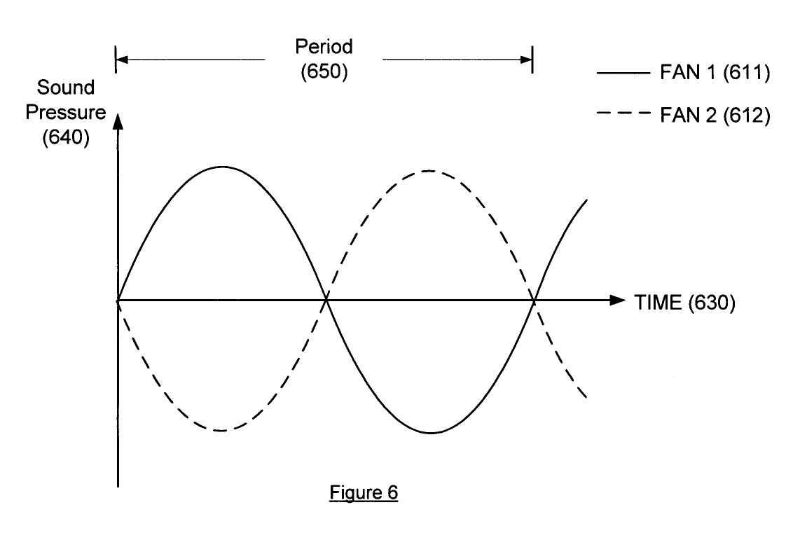

FIG. 6 shows a diagram in accordance with one or more embodiments of the system. Sound pressure (640) may correspond to one or more noise components with a period (650), of a plurality of noise components generated by fan 1 (611) and fan 2 (612). The period (650) of the noise components is then multiplied by 1/x, where x is the total number of fans in the system of fans, to determine a phase shift as shown in FIGS. 3-5. Accordingly, in a system with two fans, as shown in FIG. 6, Fan 2 (612) is configured to have a phase shift corresponding to the half the period (650) of one or more noise components; producing an inverse relationship between the sound pressure waves of one or more noise components of fan 1 (611) and fan 2 (612) as a function of time (630). The inverse relationship reduces the noise generated by one or more noise components by cancelling out noise components from different fans. The reduction in noise generated by one or more noise components thereby reduces the total noise generated by the system of fans. In one or more embodiments of the invention harmonic noise components with a relatively high frequency are used to calculate the phase shift for a plurality of fans.

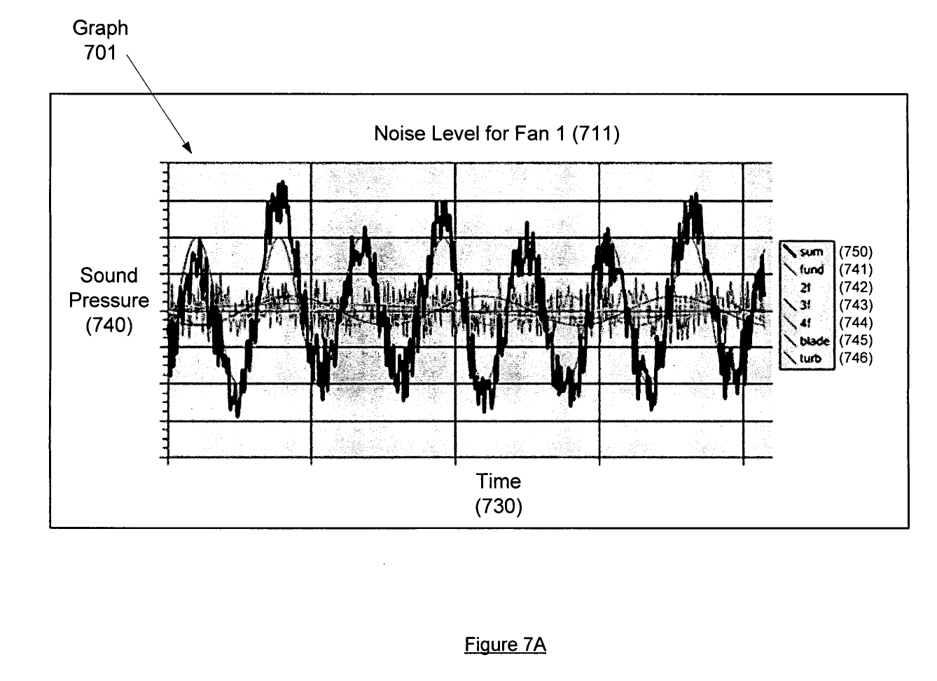

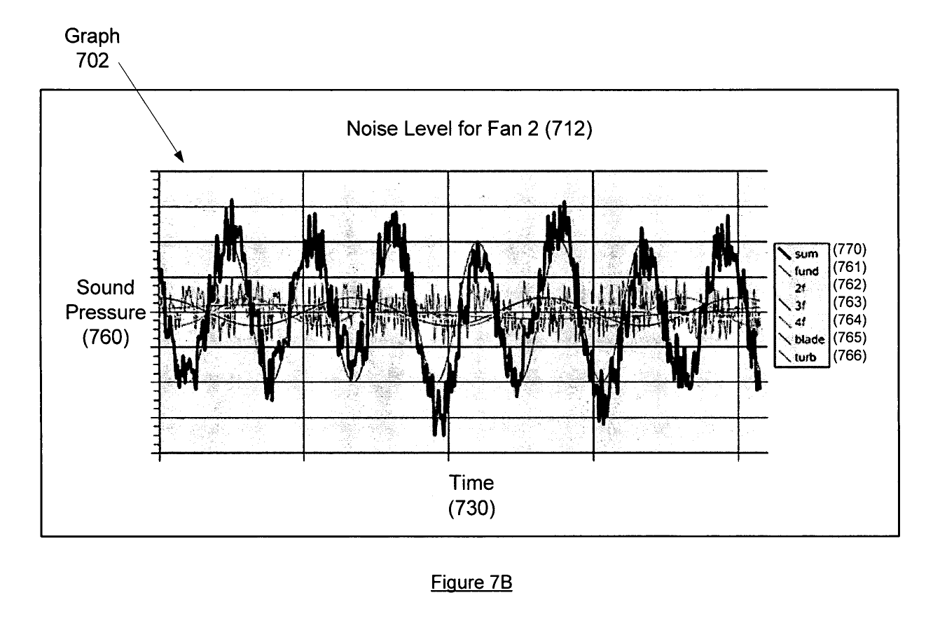

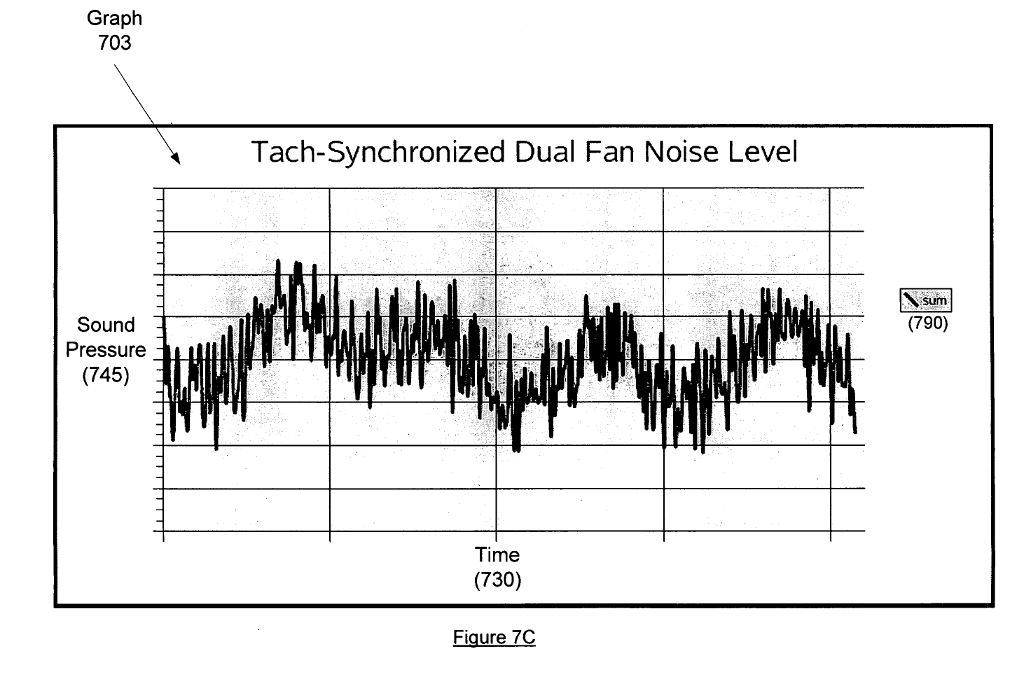

FIG. 7A shows an example of a system in accordance with one or more embodiments of the invention which in no way is intended to limit the invention. In FIG. 7A, graph (701) charts the sound pressure (740) of fan 1 (711) from a system of two fans, as a function of time (730). Fan 1 (711) is essentially the same as fan 1 (611) shown in FIG. 6. The sum (750) is the total noise emitted from fan 1 (711) and may correspond to a sum of several components, both tonal and broadband/random. The sum (750) may include but is not limited to:

a fundamental component (741), from in-plane fan imbalance and motor torque eccentricity;

a 2f harmonic component (742), usually from out-of-plane fan imbalance;

a 3f harmonic component (743), from motor drive distortion;

a 4f harmonic component (744), from drive torque ripple;

a blade-pass harmonic component (745), from air flow noise; and

a random component (746), from air flow noise, which may be white turbulence over a relatively broad frequency band.

The harmonic noise components shown in graph (701) are tonal and randomly related in phase. However, in alternate embodiments of the invention, several tonal components may be tied together in phase. In one or more embodiments of the invention, the harmonic blade pass component (745) has a relatively high magnitude and therefore may be selected as a noise component to be reduced using the invention.

FIG. 7B shows an example of a system in accordance with one or more embodiments of the invention which in no way is intended to limit the invention. Graph (702) charts the sound pressure (760) of fan 2 (712), from the same system of fans described in FIG. 7A, as a function of time (730). Fan 2 (712) is essentially the same as fan 2 (612) shown in FIG. 6. Graph (702) is similar to graph (701), however it corresponds to fan 2 (712) instead of fan 1 (711). Fan 2 (712) is configured to have a phase shift from Fan 1 (711) such that the blade pass harmonic component (745) of noise of fan 1 (711) shown in FIG. 7A has an inverse relationship with blade pass harmonic component (765) of noise of fan 2 (712) shown in FIG. 7B. The inverse relationship is similar to the inverse relationship shown in FIG. 6 between noise components from different fans. The inverse relationship of the blade pass harmonic component (745) of noise and blade pass harmonic component (765) of noise reduces the total sound in the system by cancelling each other out.

FIG. 7C shows an example of a system in accordance with one or more embodiments of the invention which in no way is intended to limit the invention. Graph (703) shows the combined sound pressure (780) of fans 1 (711) and 2 (712) as a function of time (730). Sum (790) is a sum of sum (750) from FIG. 7A and sum (770) from FIG. 7B. In this example, the blade pass harmonic component (745) from fan 1 (711) and the blade pass harmonic component (765) from fan 2 (712) were reduced by calculating the phase shift based on the period of the blade pass harmonic components (745, 765). As shown in FIG. 7C, both lower-frequency tonal components and random components are still present but blade pass harmonic components (745, 765) have been cancelled. As a result sum (790) has a lower frequency than sum (750) from FIG. 7A and sum (770) from FIG. 7B. Furthermore, the process may effectively reduce the “beating” noise.

Advantages of the present invention may include one or more of the following. In one or more embodiments of the present invention, noise is reduced without any added mechanical hardware, airflow impedance service access impediment, sensors or other transducers.

In one or more embodiments of the present invention, noise reduction is obtained without reliance on complex acoustic signals.

In one or more embodiments of the invention, noise reduction is obtained using only phase shifts, time period configurations and simple electrical controls.

In one or more embodiments of the invention, noise reduction is obtained at any fan speed including thermally-controlled variable speed designs.

In one or more embodiments of the invention, particular noise components are targeted to reduce the total noise emitted from the system.

In one or more embodiments of the invention, the “beating” noise due to differences in speed between adjacent fans is reduced.

In one or more embodiments of the invention, noise reduction is obtained while maintaining easy hot-swap serviceability of air movers, using the short height and depth available to them within a compact system chassis, and without an added chassis volume requirement.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for reducing noise generated by a plurality of fans, comprising:
setting a first fan of the plurality of fans at a predetermined speed;
setting a second fan of the plurality of fans at the predetermined speed; and
configuring the second fan of the plurality of fans to have a phase shift from the first fan of the plurality of fans.

2. The method of claim 1, further comprising:
using a fan tachometer signal to control a speed and a phase of each fan in the plurality of fans.

3. The method of claim 1, wherein the phase shift is configured to reduce a harmonic noise component.

4. The method of claim 3, wherein the noise component is a blade-pass component.

5. The method of claim 3, wherein the phase shift is a fraction of the noise component period.

6. The method of claim 5, wherein the fraction is 1/x, wherein x is a total number of fans in the plurality of fans.

7. The method of claim 1, wherein the predetermined speed is temporally variable.

8. A method for reducing noise generated by a plurality of fans, comprising:
setting a first subgroup of fans of the plurality of fans at a predetermined speed;
setting a second subgroup of fans of the plurality of fans at the predetermined speed; and
configuring the second subgroup of fans of the plurality of fans to have a phase shift from the first subgroup of fans of the plurality of fans.

9. The method of claim 8, wherein the first subgroup of fans of the plurality of fans are mounted in parallel.

10. The method of claim 8, wherein the first subgroup of fans of the plurality of fans are closely-mounted in serial.

11. A system for moving air using a plurality of fans, comprising:
a first fan of the plurality of fans,
wherein the first fan is set to a predetermined speed; and
a second fan of the plurality of fans,
wherein the second fan is set to the predetermined speed,
wherein the second fan of the plurality of fans is configured to have a phase shift from the first fan of the plurality of fans.

12. The system of claim 11, further comprising:
a fan tachometer signal used to control a speed and phase of each fan in the plurality of fans.

13. The system of claim 11, wherein the phase shift is configured to reduce a harmonic noise component.

14. The system of claim 13, wherein the noise component is a blade-pass component.

15. The system of claim 13, wherein the phase shift is a fraction of the noise component period.

16. The system of claim 15, wherein the fraction is 1/x, wherein x is a total number of fans in the plurality of fans.

17. The system of claim 11, wherein the predetermined speed is temporally variable.

18. A system for moving air using a plurality of fans, comprising:
a first subgroup of fans of the plurality of fans,
wherein the first subgroup of fans is set to a predetermined speed; and
a second subgroup of fans of the plurality of fans,
wherein the second subgroup of fans is set to the predetermined speed,
wherein the second subgroup of fans of the plurality of fans is configured to have a phase shift from the first subgroup of fans of the plurality of fans.

19. The system of claim 18, wherein the first subgroup of fans of the plurality of fans are mounted in parallel.

20. The system of claim 18, wherein the first subgroup of fans of the plurality of fans are closely mounted in series.
